(19) United States
(12) Patent Application Publication
(10) Pub. No.: US 2022/0398251 A1
(43) Pub. Date: Dec. 15, 2022

(54) DATA PROCESSING SYSTEM AND METHOD FOR IMPLEMENTING A SEARCH ENGINE BASED ON DETECTING INTENT FROM A SEARCH STRING

(71) Applicant: Bank of America Corporation, Charlotte, NC (US)

(72) Inventors: Ravisha Andar, Plano, TX (US); Ramakrishna Reddy Yannam, The Colony, TX (US); Jean-Luc M. Kamin, Minneapolis, MN (US); Saahithi Chillara, Allen, TX (US); Devanshu Mukherjee, Frisco, TX (US); Priyank R. Shah, Frisco, TX (US); Emad Noorizadeh, Plano, TX (US); Shylaja Vijayaraghavan, Frisco, TX (US); David Henry Witting, Seattle, WA (US)

(21) Appl. No.: 17/347,231

(22) Filed: Jun. 14, 2021

(51) Int. Cl. G06F 16/2457; G06F 16/9535; G06F 16/9538; G06F 16/93; G06Q 10/10

(52) U.S. Cl. CPC G06F 16/24578; G06F 16/9535; G06F 16/9538; G06F 16/93; G06Q 10/1095

(57) ABSTRACT

A system for determining search results for a search string based on detecting an intent from the search string receives the search string. The system determines the intent of the search string by extracting a first set of features from the search string. The first set of features represent the intent. The system compares the first set of features with a second set of features labeled with an intent tag stored in a training dataset. The system determines whether the first set of features corresponds to the second set of features. In response to determining that the first set of features corresponds to the second set of features, the system determines that the first intent tag corresponds to the intent of the search string. The system produces a search result for the search string, where a first item in the search result is a text associated with the intent tag.

### TECHNICAL FIELD

The present disclosure relates generally to data processing, and more specifically to data processing system and method for implementing a search engine based on detecting intent from a search string.

### BACKGROUND

It is challenging to produce an accurate search result that includes responses for an input text (also referred to herein as “search term(s)” or a “query”). In some cases, the current search engines may include irrelevant links or documents in the search results. For example, the current search engine may perform a simple string matching to determine the search results. However, implementing simple string matching techniques leads to producing irrelevant search results. Current technologies are not configured to provide a reliable and efficient search engine.

### SUMMARY

Current technologies are not configured to provide a reliable and efficient search engine. This disclosure contemplates systems and methods for implementing a search engine based on detecting intents from search strings.

The disclosed system is configured to detect an intent from a search string (e.g., input by a user) by extracting a set of features from the search string. The set of features may represent an intent associated with the search string. The intent may represent contextual data and the concept of the search string. The set of features may be represented by one or more keywords. For example, the search string may include “I want to see someone about my account.” The set of features may include one or more keywords of the search string. In this example, the intent of the search string may be “schedule an appointment.”

Upon determining the intent of the search string, the disclosed system may identify a text that comprises a response to the search string. To identify the text that comprises the response to the search string, the disclosed system compares the set of features extracted from the search string with features previously extracted from a plurality of text strings and labeled with a plurality of intent tags stored in a training dataset. In the training dataset, each intent tag from among the plurality of intent tags is associated with one or more text strings. Each text string is associated with a set of features representing a corresponding intent tag. Each intent tag is associated with a particular text that comprises a response to a search string.

For example, assume that the disclosed system compares the first set of features (extracted from the search string) with a second set of features (associated with a first intent tag and a text string associated with the first intent tag). The disclosed system determines whether the first set of features corresponds to the second set of features.

In this operation, the disclosed system calculates a confidence score indication a probability of the first set of features corresponding the second set of features. The confidence score may further indicate a percentage of features of the first set of features that correspond to counterpart features of the second set of features.

If the disclosed system determines that the confidence score is more than a threshold percentage, the disclosed system determines that the intent of the search string corresponds to the first intent tag. In this case, the disclosed system determines that a first item in a search result for the search string should be a first text associated with the first intent tag, where the first text comprises a response to the search string.

In one embodiment, the disclosed system may determine that other items in the search result for the search string should include documents in which a frequency of occurrence of each keyword associated with the search string is more than a threshold frequency. The disclosed system may rank these documents based on the frequency of occurrence of each keyword associated with the search string.

In another embodiment, the disclosed system may determine that other items in the search result for the search string should include documents that are associated with search indexes that correspond to the keywords associated with the search string.

The disclosed system may compare the set of features (extracted from the search string) with other sets of features associated with other intent tags, and thus calculate multiple confidence scores each indicating whether the intent of the search string corresponds to different intent tags. If the disclosed system determines that none of the confidence scores is more than the threshold percentage, the disclosed system may determine that the items in the search result for the search string may include documents in which the frequency of occurrence of each keyword associated with the search string is more than a threshold frequency and/or documents that are associated with search indexes that correspond to the keywords associated with the search string.

In one embodiment, a system for determining search results for a search string based on detecting intent from the search string comprises a memory and a processor. The memory is operable to store a training dataset comprising a first intent tag associated with at least a first string. The first intent tag indicates a first intent of the first string. The first string is associated with a first set of features representing the first intent of the first string. The first intent tag is predetermined to be associated with a first text comprising a response to the first string. The processor is operably coupled with the memory. The processor receives a search string. The processor determines an intent from the search string by extracting a second set of features from the search string. The second set of features represents the intent. The intent is indicated by one or more particular keywords. The processor compares the second set of features with the first set of features. The processor determines whether the second set of features corresponds with the first set of features by determining a percentage of features of the second set of features that correspond to counterpart features of the first set of features. In response to determining that the percentage of features of the second set of features that correspond to the counterpart features of the first set of features is more than a threshold percentage, the processor determines that the intent corresponds to the first intent tag. The processor produces a search result for the search string, where a first item in the search result is the first text. The processor outputs the search result.

The disclosed system provides several practical applications and technical advantages, which include: 1) technology that detects an intent from a search string based on extracting a set of features from the search string, where the set of features represents contextual data, concept, and intent of the search string; 2) technology that uses a training dataset comprising a plurality of intent tags each associated with a different set of features to compare the set of features (extracted from the search string) with the different sets of features and determine a particular set of features (associated with a particular intent tag) that correspond to the set of features (extracted from the search string); 3) technology that calculates a confidence score indicating a probability of the particular set of features (associated with the particular intent tag) corresponding to the set of features (extracted from the search string); 4) technology that determines that the particular intent tag corresponds to the intent of the search string if the confidence score is more than a threshold percentage; 5) technology that produces search results for the search string based on the detected intent; 6) technology that determines that a first item in the search results is a first text associated with the particular intent tag, and the first text comprises a response to the search string; and 7) technology that determines that other items in the search results include documents in which the frequency of occurrence of each keyword associated with the search string is more than a threshold frequency and/or documents that are associated with search indexes that correspond to the keywords associated with the search string.

As such, the disclosed system may improve the current search engine and text processing technologies, for example, by implementing an intent- or intention-based search engine that detects an intent of a search string, and determines a particular text that comprises a response to a search string.

Accordingly, the disclosed system may be integrated into a practical application of providing the most relevant response to the search string by detecting the particular text based on the detected intent of the search string. In this manner, the most relevant response to the search string is placed at the top of the search result of the search string. This, in turn, provides an additional practical application of excluding documents that include less relevant responses to the search string compared to the particular text that includes the most relevant response to the search string, even though those documents comprise more than a threshold frequency of occurrences of keywords associated with the search string and/or indexed with search indexes associated with the keywords of the search string. Thus, excluding the less relevant responses to the search string from the research results improves the usage of storage capacity of computer memory and thereby makes the underlying computer technologies operate more efficiently.

The disclosed system may further be integrated into an additional practical application of excluding documents that include less relevant responses to the search string compared to the particular text that includes the most relevant response to the search string, where those documents are otherwise determined by the current search engine and text processing technologies.

The disclosed system may further be integrated into an additional practical application and technical improvement over current technologies by improving the search engine, text processing, and computing technologies, and improving a computer system by providing technical solution of detecting an intent of a search string, and detecting the most relevant response to the search string. Thus, the disclosed system provides a technical solution to the problem of producing a search result that includes the most relevant response to the search string.

By producing the search result that includes the text comprising the most relevant response to the search string, the disclosed system may further be integrated into an additional practical application of reducing the size of the search result by excluding documents that include less relevant responses to the search string.

The disclosed system may further be integrated into an additional practical application of improving underlying operations of computing devices tasked to process the search string and produce the search results for the search string.

This, in turn, provides an additional practical application, including ease of use, fewer resources needed, faster implementation and response, and more accurate research results. For example, the disclosed system may decrease processing, memory, and time resources spent on processing the search string and producing the search result that would otherwise be spent using the current search engine and text processing technologies. Thus, the search results are more accurate, produced faster, and require less processing, memory, and time resources compared to the current search engines.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured for implementing a search engine based on detecting intent from a search string; and

FIG. 2 illustrates an example flowchart of a method for implementing a search engine based on detecting intent from a search string.

### DETAILED DESCRIPTION

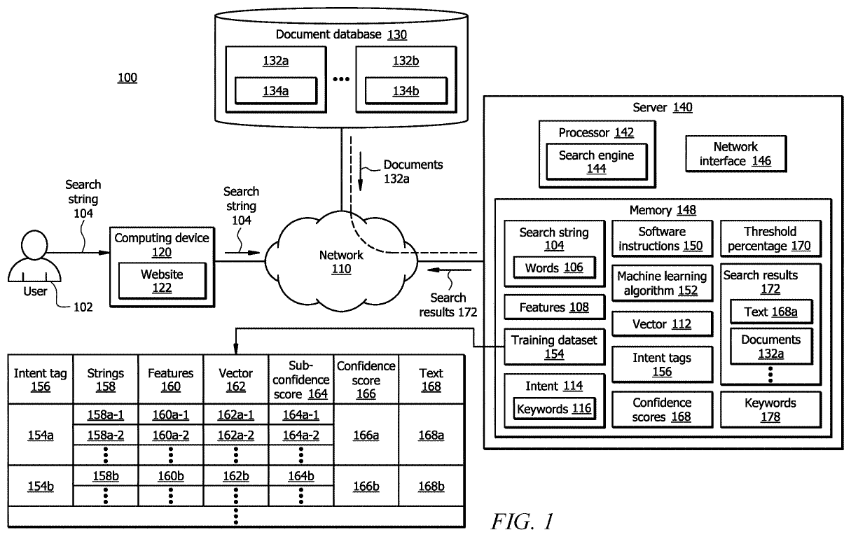

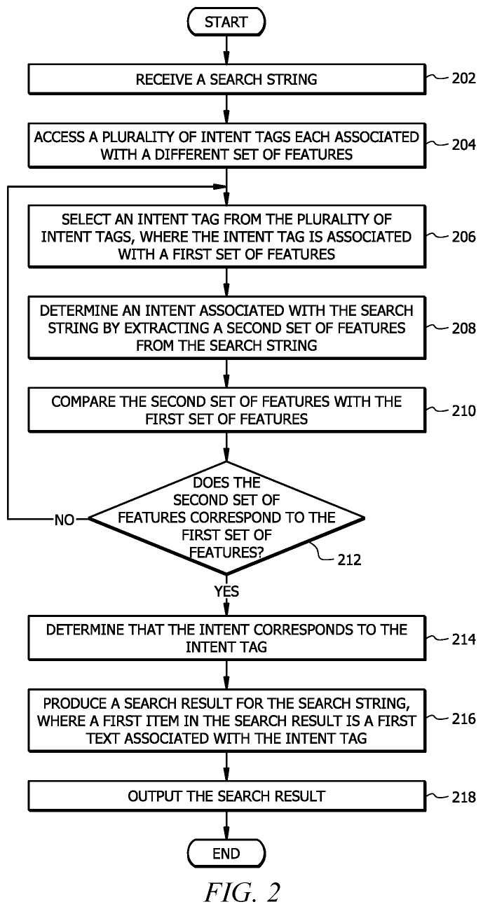

As described above, previous technologies fail to provide efficient and reliable solutions for search engines. This disclosure provides various systems and methods for detecting an intent from a search string, and implementing a search engine using the detected intent. In one embodiment, system 100 and method 200 for detecting an intent from a search string, and implementing a search engine using the detected intent are described in FIGS. 1 and 2, respectively.

### Example System for Implementing a Search Engine Based on Detecting Intent

FIG. 1 illustrates one embodiment of a system 100 that is configured to implement a search engine 144 to detect intents 114 from search strings 104. In one embodiment, system 100 comprises a server 140. In some embodiments, system 100 further comprises a network 110, a computing device 120, and a document database 130. The server 140 comprises a processor 142 in signal communication with a memory 148. Memory 148 stores software instructions 150 that when executed by the processor 142, cause the processor 142 to detect an intent 114 from a search string 104, and determine a text 168 that includes a response to the search string 104 based on the detected intent 114. Document database 130 stores a plurality of documents 132 that may be used by the memory 148 and/or the processor 142. In other embodiments, system 100 may not have all of the components listed and/or may have other elements instead of, or in addition to, those listed above.

### System Components

Network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

Computing device 120 is generally any device that is configured to process data and interact with users 102. Examples of computing device 120 include, but are not limited to, a personal computer, a desktop computer, a workstation, a server, a laptop, a tablet computer, a mobile phone (such as a smartphone), etc. The computing device 120 may include a user interface, such as a display, a microphone, keypad, or other appropriate terminal equipment usable by user 102. The computing device 120 may include a hardware processor, memory, and/or circuitry configured to perform any of the functions or actions of the computing device 120 described herein. For example, a software application designed using software code may be stored in the memory and executed by the processor to perform the functions of the computing device 120.

The user 102 may input one or more words 106 in a search text field on a website 122. For example, the user 102 may input a search string 104 that comprises one or more words 106 in a text field on the website 122. For example, assuming that the user 102 wants to make an appointment with an employee of an organization associated with the website 122, the search string 104 may include “I want to make an appointment with someone,” “I want to sit down with someone to discuss my options,” “I want to meet with an employee to talk about my account,” or any other search strings 104. In this example, the intent 114 associated with the search string 104 is to make an appointment.

In another example, the user 102 may input a search string 104 to view an existing appointment. In this case, the user 102 may input “how can I see my appointment,” “show my current appointments,” or any other search strings 104. In this example, the intent 114 associated with the search string 104 is to view the existing appointment.

In another example, the user 102 may input a search string 104 to edit an existing appointment. In this case, the user 102 may input “how can I edit my schedule at LOAM,” “how can and reschedule my appointment,” or any other search strings 104. In this example, the intent 114 associated with the search string 104 is to edit the existing appointment.

In other examples, the search string 104 may be related to any topic or concept, e.g., web design, accounting, etc., As such, the intent 114 of the search string 104 may be related to any topic or concept. The search engine 144 processes the received search string 104 from the computing device 120 and via network 110, predicts the intent 114 associated with the search string 104, and determines a text 168 that includes a response to the search string 104. This process is described in detail in conjunction with the operational flow of system 100 and method 200 described in FIG. 2.

Document database 130 generally comprises any storage architecture. Examples of document database 130 include, but are not limited to, a network-attached storage cloud, a storage area network, a storage assembly directly (or indirectly) coupled to one or more components of the system 100. The document database 130 stores a plurality of documents 132. Each document 132 comprises a particular set of keywords 134 indicating a particular concept associated with document 132. In other words, each document 132 is mapped to a particular concept. For example, a first document 132a may comprise a first set of particular keywords 134a indicating a first concept, a second document 132b may comprise a second set of particular keywords 134b indicating a second concept, and so on. The document database 130 may store any other data and/or instruction to be used by the memory 148 and/or the processor 142 to perform one or more functions described herein.

The search engine 144 may fetch one or more documents 132 from the document database 130 to perform one or more functions described herein. For example, the search engine 144 may add one or more documents 132, or a subset of documents 132 to a search result 172 for a search string 104. In one example, the search engine 144 may add one or more documents 132 to the search result 172, where each of the one or more document 132 include keywords 116, and a frequency of occurrence of each keyword 116 is more than a threshold frequency (e.g., more than 20, 40, etc.). In another example, the search engine 144 adds one or more documents 132 to the search result 172, where each of the one or more documents 132 include words 106, and a frequency of occurrence of each word 106 is more than a threshold frequency (e.g., more than 20, 40, etc.). In another example, the search engine 144 adds one or more documents 132 to the search result 172, where each of the one or more documents 132 is indexed or labeled with one or more keywords 116 and/or words 106, such as search indexes. The search engine 144 may rank the one or more documents 132 based on the frequency of occurrences of keywords 116 and/or words 106. This process is described in detail in conjunction with the operational flow of system 100 and method 200 described in FIG. 2.

### Server

Server 140 is generally a server or any other device configured to process data and communicate with computing devices (e.g., computing device 120), databases (document database 130), etc., via the network 110. The server 140 is generally configured to oversee the operations of the search engine 144, as described further below in conjunction with an operational flow of system 100 and method 200 described in FIG. 2. The server 140 may be configured as shown or in any other configuration.

Processor 142 comprises one or more processors operably coupled to the memory 148. The processor 142 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 142 may be a programmable logic device, a microcontroller, a microprocessor, or any suitable combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations, processor 142 registers the supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions (e.g., software instructions 150) to implement the search engine 144. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-2. For example, the processor 142 may be configured to perform one or more steps of method 200 as described in FIG. 2.

Network interface 146 is configured to enable wired and/or wireless communications (e.g., via network 110). The network interface 146 is configured to communicate data between the server 140 and other devices (e.g., computing device 120), databases (e.g., document database 130), systems, or domains. For example, the network interface 146 may comprise a WIFI interface, a local area network (LAN) interface, a wide area network (WAN) interface, a modem, a switch, or a router. The processor 142 is configured to send and receive data using the network interface 146. The network interface 146 may be configured to use any suitable type of communication protocol as would be appreciated by one of ordinary skill in the art.

Memory 148 may be volatile or non-volatile and may comprise a read-only memory (ROM), random-access memory (RAM), ternary content-addressable memory (TCAM), dynamic random-access memory (DRAM), and static random-access memory (SRAM). Memory 148 may be implemented using one or more disks, tape drives, solid-state drives, and/or the like. Memory 148 is operable to store the software instructions 150, machine learning algorithm 152, training dataset 154, intent tags 156, confidence scores 166, search strings 104, features 108, vector 112, intent 114, search results 172, keywords 178, threshold percentage 170, and/or any other data or instructions. The software instructions 150 may comprise any suitable set of instructions, logic, rules, or code operable to execute the processor 142.

### Search Engine

Search engine 144 may be implemented by the processor 142 executing software instructions 150, and is generally configured to 1) detect an intent 114 from a search string 104; 2) identify a text 168 that includes a response to the search string 104; and 3) output search results 172 for the search string 104 that includes the text 168. Each of these processes are described in detail further below in conjunction with the operational flow of system 100 and method 200 described in FIG. 2.

In one embodiment, the search engine 144 may be implemented by a machine learning algorithm 152. For example, the machine learning algorithm 152 may comprise support vector machine, neural network, random forest, k-means clustering, etc. The machine learning algorithm 152 may be implemented by a plurality of neural network (NN) layers, Convolutional NN (CNN) layers, Long-Short-Term-Memory (LSTM) layers, Bi-directional LSTM layers, Recurrent NN (RNN) layers, and the like. In another example, the machine learning algorithm 152 may be implemented by a Natural Language Processing (NLP). In another example, the machine learning algorithm 152 may be implemented by analog signal processing, digital signal processing, speech signal processing, signal quantization, signal frequency sampling, among others.

The search engine 144 may be trained by the training dataset 154. In one embodiment, the training dataset 154 may comprise a plurality of intent tags 156. Each intent tag 156 may be associated with one or more text strings 158. Each intent tag 156 indicates an intent associated with its corresponding strings 158. For example, the intent tag 154a may be associated with one or more strings 158a that may include strings 158a-1, 158a-2, and so on. The intent tag 154a may indicate a first intent of the strings 158a including strings 158a-1, 158a-2, etc. For example, assume that the intent tag 154a is scheduling an appointment. Thus, some examples of the strings 158a may include “set an appointment,” “set up reservation regarding my account,” “I need an appointment with someone about the account,” “see someone,” “see a specialist about account,” “how to schedule an appointment,” and/or other strings 158a whose intent is to schedule an appointment.

Similarly, the intent tag 154b may be associated with one or more strings 158b. The intent tag 154b may indicate a second intent of the strings 158b. For example, assume that the intent tag 154b is editing an appointment. Thus, some examples of the strings 158b may include “edit an appointment,” “how can I reschedule my appointment,” “I need to revise my scheduled appointment,” and/or other strings 158b whose intent is to edit an appointment.

In one embodiment, each string 158 in the training dataset 154 may be associated with a set of features 160. The set of features 160 represents an intent of its corresponding strings 158. In other words, the set of features 160 represents an intent tag 156 of the corresponding string 158, and may be used to uniquely identify its corresponding intent tag 156.

Each set of features 160 may be represented by a vector 162. Each vector 162 may comprise a set of numerical values. For example, the string 158a-1 is associated with the set of features 160a-1 represented by a vector 162a-1, the string 158a-2 is associated with the set of features 160a-2 represented by a vector 162a-2, where each of the set of features 160a-1 and 160a-2 may be used to uniquely identify the intent tag 156a. Similarly, the string 158b is associated with the set of features 160b represented by a vector 162b, and so on.

In one embodiment, the search engine 144 may extract features 160 from strings 158 by implementing the machine learning algorithm 152 including natural language processing.

In one embodiment, each intent tag 156 in the training dataset 154 may be associated with one set of features 160.

Each intent tag 156 may be predetermined to be associated with a particular text 168. Each text 168 may comprise a response to a different search string 104. For example, the intent tag 156a may be predetermined to be associated with a text 168a, the intent tag 156b may be predetermined to be associated with a text 168b, and so on.

The search engine 144 may use the training dataset 154 to determine an intent 114 of a search string 104. To determine an intent 114 of a search string 104, the search engine 144 extracts features 108 from the search string 104, and compares the features 108 with features 160.

The search engine 144 determines a set of features 160 (e.g., set of features 160a, 160b, etc.) that corresponds to the features 108. For example, the search engine 144 calculates confidence scores 166 each indicating a percentage of the set of features 108 corresponding to each set of features 160. In response to determining a particular set of features 160 that corresponds to the features 108, the search engine 144 determines that the intent tag 156 associated with the particular set of features 160 corresponds to the intent 114.

Although FIG. 1 describes detecting intent 114 from the search string 104, one of ordinary skill in the art would recognize other embodiments in light of this disclosure. In one embodiment, the system 100 may detect intents 114 from speech. For example, the search engine 144 may receive speech of the user 102, feed the speech to an audio signal processing, speech transcription, etc. to extract features 108, detect words 106 and keywords 116. The search engine 144 may detect the intent 114 of the speech by using the training dataset 154, similar to that described above.

### Operational Flow

Determining an Intent from a Search String

In one embodiment, the operational flow of system 100 begins when the search engine 144 receives a search string 104. For example, the search engine 144 may receive the search string 104 from the computing device 120 when the user 102 inputs the search string 104 in the website 122.

The search engine 144 extracts a set of features 108 from the search string 104. The set of features 108 may represent the intent 114 associated with the search string 104. The intent 114 may indicate the concept and contextual data associated with the search string 104. The intent 114 may be indicated by one or more particular keywords 116. The set of features 108 may be represented by one or more keywords 116. The set of features 108 may be represented by a vector 112 that comprises a set of numerical values. The search engine 144 may extract the set of features 108 by implementing the machine learning algorithm 152 including a natural language processing algorithm. In this operation, the search engine 144 may use any type of text analysis, such as word segmentation, sentence segmentation, word tokenization, sentence tokenization, word featurization, sentence featurization, and/or the like.

Identifying an Intent Tag that Corresponds to the Determined Intent

The search engine 144 compares the set of features 108 with each set of features 160, such as features 160a, 160b, etc.

In an embodiment where each string 158 is associated with a different set of features 160 for each intent tag 156, the search engine 144 may compare the set of features 108 with each set of features 160 associated with strings 158. For example, with respect to intent tag 154a, the search engine 144 may compare the set of features 108 with the set of features 160a associated with each string 158a. For example, the search engine 144 may compare the set of features 108 with the set of features 160a-1, set of features 160a-2, and other features 160a, separately.

The search engine 144 may calculate a sub-confidence score 164a indicating a percentage of features 108 from the set of features 108 that correspond to the counterpart features 160a from the set of features 160a.

For example, the search engine 144 may calculate a sub-confidence score 164a-1 indicating a percentage of features 108 from the set of features 108 that correspond to features 160a-1, calculate a sub-confidence score 164a-2 indicating a percentage of features 108 from the set of features 108 that correspond to features 160a-2, and so on. The sub-confidence score 164a-1 may further represent a probability of the intent tag 156a corresponding to the intent 114. Similarly, sub-confidence score 164a-2 may further represent a probability of the intent tag 156b corresponding to the intent 114.

In calculating the sub-confidence score 164a-1, the search engine 144 compares the vector 112 with vector 162a-1. For example, the search engine 144 may perform a dot product between the vector 112 and vector 162a-1. In this operation, the search engine 144 may compare each numerical value of the vector 112 with a counterpart numerical value of the vector 162a-1. The search engine 144 determines whether each numerical value of the vector 112 corresponds to the counterpart numerical value of vector 162a-1.

In one embodiment, in response to determining that more than a threshold percentage (e.g., more than 90%, etc.) of the numerical values of the vector 112 correspond to the counterpart numerical values of the vector 162a-1, the search engine 144 determines that the vector 112 corresponds to the vector 162a-1, and thus, features 108 correspond to features 160a-1.

In another embodiment, in response to determining that more than a threshold percentage (e.g., more than 90%, etc.) of the numerical values of the vector 112 are within a threshold range (e.g., ±5%, ±10%, etc.) of the counterpart numerical values of the vector 162a-1, the search engine 144 determines that the vector 112 corresponds to the vector 162a-1, and thus, features 108 correspond to features 160a-1. The search engine 144 may perform a similar operation in comparing the vector 112 with other vectors 162.

The search engine 144 may calculate the confidence score 166a by taking an average of the sub-confidence scores 164a-1, 164a-2, and other sub-confidence scores 164a. The confidence score 166a may represent a percentage of features 160a (e.g., features 160a-1, 160a-2, etc.) that corresponds to the features 108. The search engine 144 may calculate other confidence scores 166 associated with other intent tags 156, similar to that described above. In one embodiment, the search engine 144 may normalize the calculated confidence scores 166, such that the addition of the calculated confidence scores 166 is 100%.

In response to determining that the confidence score 166a is above a threshold percentage 170 (e.g., more than 90%, 95%, etc.), the search engine 144 determines that the intent 114 corresponds to the intent tag 154a. In other words, if the search engine 144 determines that the set of features 160a (including one or more of features 160a-1, 160a-2, and other features 160a) corresponds to the set of features 108, the search engine 144 determines that the intent 114 corresponds to the intent tag 154a.

### Producing Search Results for the Search String

In one embodiment, the search engine 144 produces the search result 172 by determining that a first item in the search results 172 for the search string 104 should be the first text 168a. The search engine 144 may add one or more documents 132 as other items in the search results 172.

In response to determining that none of the confidence scores 166 is above the threshold percentage 170, the search engine 144 may not add any of the text 168 in the search result 172, and instead add one or more documents 132 to the search result 172, as described below.

The search engine 144 may add one or more documents 132 from documents 132 to the search results 172. The search engine 144 may select the one or more documents 132a by parsing the documents 132 and determining that in the one or more documents 132a, a frequency of occurrence of each keyword 116 (or more than threshold percentage of the keywords 116, e.g., more than 90% of the keywords 116) is more than a threshold frequency (e.g., 20, 40, etc.).

In one embodiment, in this process, the search engine 144 may determine a frequency of occurrence of each keyword 116 and/or word 106 in each document 132 by implementing a text parsing algorithm. The search engine 144 may rank the documents 132 based on the determined frequency of occurrence of each keyword 116 and/or word 106 in each document 132. For example, a first document 132a in which the frequency of occurrence of each keyword 116 and/or word 106 is higher than a frequency of occurrence of a counterpart keyword 116 and/or word 106 in other documents 132 is ranked higher than the other documents 132. In this example, the search engine 144 adds the first document 132a as a second item in the search results 172.

The search engine 144 may determine that the other items in the search result 172 are a subset of documents 132 in which the determined frequency of occurrence of each keyword 116 and/or word 106 is above a threshold frequency.

In one embodiment, the search engine 144 may exclude documents 132 that include keywords 116 and/or words 106 more than a threshold number (e.g., more than the threshold frequency of occurrence) yet include an irrelevant response to the search string 104. For example, the search engine 144 may determine that these documents 132 include an irrelevant response to the search string 104 by executing a natural language processing, determining a concept and intent of these document, and determining that these intents do not correspond to the intent 114.

In this manner, the search engine 144 may determine the text 168a that includes the most relevant response to the search string 104, and exclude documents 132 that include less relevant responses to the search string 104 compared with the text 168a from the search result 172. Thus, the search results 172 includes the most relevant response to the search string 104, and the size of the search result 172 is reduced by excluding documents 132 that include less relevant responses to the search string 104 compared with the text 168a.

The search engine 144 then outputs the search results 172 to the computing device 120, such that the search results 172 are displayed on the website 122.

In response to outputting the search results 172, the search engine 144 may receive feedback (e.g., from the user 102) indicating whether the first text 168a comprises a response to the search string 104. In response to receiving the feedback that indicates that the first text 168a does not comprise the response to the search string 104, the search engine 144 may adjust one or more weight values associated with the features 108 and/or one or more features 160a.

In this manner, the search engine 144 may increase the accuracy of the search results 172 and the classification of intent tags 156 with strings 158 in the training dataset 154.

Although, FIG. 1 described receiving a search string 104, one of ordinary skill in the art may recognize other embodiments in light of this disclosure. For example, in one embodiment, the search engine 144 may receive an audio signal that includes speech of the user 102 as a search string 104, where the audio signal includes one or more utterances or words 106. Thus, the search engine 144 may execute an audio signal processing, speech signal processing, and/or the like to extract features 108 from the audio signal, compare the features 108 with features 160, and detect the intent 114 of the audio signal, similar to that described above with respect to search string 104.

### Example Method for Implementing a Search Engine Based on Detecting Intent

FIG. 2 illustrates an example flowchart of a method 200 for implementing a search engine 144 based on detecting intent 114 from a search string 104. Modifications, additions, or omissions may be made to method 200. Method 200 may include more, fewer, or other steps. For example, steps may be performed in parallel or in any suitable order. While at times discussed as the system 100, processor 142, search engine 144, or components of any of thereof performing steps, any suitable system or components of the system may perform one or more steps of the method 200. For example, one or more steps of method 200 may be implemented, at least in part, in the form of software instructions 150 of FIG. 1, stored on non-transitory, tangible, machine-readable media (e.g., memory 148 of FIG. 1) that when run by one or more processors (e.g., processor 142 of FIG. 1) may cause the one or more processors to perform steps 202-218.

The method 200 beings at step 202 where the search engine 144 receives a search string 104. For example, the search engine 144 may receive the search string 104 from the computing device 120 when the user 102 inputs the search string 104 on the website 122, similar to that described in FIG. 1.

At step 204, the search engine 144 accesses a plurality of intent tags 156 each associated with a different set of features 160. For example, the search engine 144 may access the intents tags 156 each labeled with a different text 168 stored in the memory 148.

At step 206, the search engine 144 selects an intent tag 156 from the plurality of intent tags 156, where the intent tag 156 is associated with a first set of features 160. For example, assume that the search engine 144 selects the intent tag 156a. The intent tag 156a is associated with the set of features 160a including features 160a-1, 160a-2, and other features 160a. In one embodiment, the search engine 144 may iteratively select an intent tag 156 until there is not more intent tag 156 is left for evaluation. In this embodiment, the search engine 144 may calculate confidence scores 166 for multiple intent tags 156, and select a particular intent tag 156 whose confidence score 166 is above the threshold percentage 170 and/or is the highest among the calculated confidence scores 166. In another embodiment, the search engine 144 may iteratively select an intent tag 156 until a particular intent tag 156 is found whose features 160 correspond to the features 108 (described in step 212).

At step 208, the search engine 144 determines an intent 114 associated with the search string 104 by extracting a second set of features 108 from the search string 104. For example, the search engine 144 may implement a natural language processing algorithm to extract the second set of features 108, similar that described above in FIG. 1. The second set of features 108 may be represented by the vector 112 that comprises a set of numerical values.

At step 210, the search engine 144 compares the second set of features 108 with the first set of features 160a. For example, with respect to intent tag 156a, the search engine 144 may compare the set of features 108 with features 160a-1 to determine whether the set of features 108 corresponds to the set of features 160a-1. In comparing the set of features 108 with the set of features 160a-1, the search engine 144 may compare the vector 112 that represents the set of features 108 with the vector 162a-1 that represents the set of features 160a-1, similar to that described above in FIG. 1. The search engine 144 calculates the sub-confidence score 164a-1 indicating a percentage of features 108 corresponding to the features 160a-1.

The search engine 144 may compare the set of features 108 with other features 160a associated with other strings 158a associated with the intent tag 156a. For example, the search engine 144 may compare the set of features 108 with features 160a-2 to determine whether the features 108 corresponds to the set of features 160a-2 by comparing the vector 112 with the vector 162a-2, and calculate the sub-confidence score 164a-2 indicating a percentage of features 108 that correspond to the features 160a-2.

In another example where the intent tag 154a is associated with one set of features 160a, the search engine 144 may compare the set of features 108 with the set of features 160a.

The search engine 144 calculates the confidence score 166a by taking an average of the sub-confidence scores 164a including sub-confidence scores 164a-1, 164a-2, and other sub-confidence scores 164a. The confidence score 166a may indicate a percentage of features 160a that correspond to the features 108. The confidence score 166a may further indicate a probability of the intent tag 156 corresponding to the intent 114.

At step 212, the search engine 144 determines whether the second set of features 108 corresponds to the first set of features 160a. The search engine 144 determines whether the second set of features 108 corresponds to the first set of features 160a by determining whether the confidence score 166a is above the threshold percentage 170. The search engine 144 may determine that the second set of features 108 corresponds to the first set of features 160a if the confidence score 166a is above the threshold percentage 170. In this process, the search engine 144 may determine whether the second set of features 108 corresponds to the first set of features 160a by determining whether the vector 112 corresponds to the vector 162a-1. The search engine 144 may determine whether the vector 112 corresponds to the vector 162a-1 by performing a dot product between the vector 112 and vector 162a-1.

In one embodiment, the search engine 144 may perform the dot product between the vector 112 and vector 162a-1 by comparing each numerical value of the vector 112 with a counterpart numerical value of vector 162a-1, similar to that described in FIG. 1.

In another embodiment, the search engine may calculate an Euclidean distance between the vector 112 and vector 162a-1, and determine that the vector 112 corresponds to the vector 162a-1 if the Euclidean distance between them is less a threshold distance percentage (e.g., within 1%, 2%, 5%, etc.). If the search engine 144 determines that the second set of features 108 corresponds to the first set of features 160a, method 200 proceeds to step 214. Otherwise, method 200 returns to step 206.

At step 214, the search engine 144 determines that the intent 114 corresponds to the intent tag 156a.

At step 216, the search engine 144 produces the search result 172 for the search string 104, where the first item in the search result 172 is the text 168a associated with the intent tag 156a. In this process, the search engine 144 determines that the first item in the search result 172 for the search string 104 should be the text 168a. The search engine 144 may also determine other items in the search results 172 should be the documents 132a that include keywords 116 each with a frequency of occurrence more than a threshold frequency, where the documents 132a are ranked based on the frequency of occurrences of the keywords 116, similar to that described in FIG. 1. In one embodiment, if the search engine 144 determines that none of the intent tags 156 correspond to the intent 114, i.e., determines that none of the confidence scores 166 is above the threshold percentage 170, the search engine may not add any text 168 to the search result 172, and instead add the documents 132 ranked based on the frequency of occurrences of the keywords 116.

At step 218, the search engine 144 outputs the search result 172. For example, the search engine 144 may communicate the search results 172 to the computing device 120 to be displayed on the website 122.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system for determining search results for a search string based on detecting intent from the search string, comprising:
a memory operable to store a training dataset comprising a first intent tag associated with at least a first text string among one or more text strings, wherein:
the first intent tag indicates a first intent of the first text string;
the first text string is associated with a first set of features representing the first intent of the first text string; and
the first intent tag is predetermined to be associated with a first text comprising a first response to the first text string;
a processor, operably coupled with the memory, and configured to:
receive the search string;
determine an intent from the search string by extracting a second set of features from the search string, wherein:
the second set of features represents the intent of the search string; and
the intent is indicated by one or more particular keywords in the search string;
compare the second set of features of the search string with the first set of features of the first text string to detect the intent from the search string;
determine whether the second set of features corresponds with the first set of features by determining a percentage of features of the second set of features that correspond to counterpart features of the first set of features;
in response to determining that the percentage of features of the second set of features that correspond to the counterpart features of the first set of features is more than a threshold percentage:
determine that the intent corresponds to the first intent tag;
produce a search result for the search string, wherein a first item in the search result is the first text associated with the first intent tag, and the first text comprises a second response to the search string; and
output the search result for the search string.

2. The system of claim 1, wherein:
the first set of features is represented by a first vector comprising a first set of numerical values,
the second set of features is represented by a second vector comprising a second set of numerical values,
determining whether the second set of features corresponds with the first set of features comprises:
comparing each numerical value of the first vector with a counterpart numerical value of the second vector;
determining whether each numerical value of the first vector corresponds to the counterpart numerical value of the second vector; and
in response to determining that more than the threshold percentage of the first set of numerical values correspond to counterpart numerical values of the second set of numerical values, determining that the second set of features corresponds with the first set of features.

3. The system of claim 1, wherein:
the training dataset further comprises a second intent tag associated with at least a second text string among the one or more text strings,
the second text string is associated with a third set of features, and
the processor is further configured to:
compare the third set of features with the first set of features;
determine whether the third set of features corresponds with the first set of features by determining a second percentage of features of the third set of features that correspond to the counterpart features of the first set of features; and
in response to determining that the second percentage of features of the third set of features that correspond to the counterpart features of the first set of features is less than the threshold percentage, determine that the second intent tag does not correspond with the intent.

4. The system of claim 1, wherein:
the memory is further operable to store a plurality of documents,
each document from the plurality of documents comprises a particular set of keywords indicating a particular concept associated with each document, and
the processor is further configured to:
in response to determining that the percentage of features of the second set of features that correspond to the counterpart features of the first set of features is less than the threshold percentage:
determine a frequency of occurrence of each keyword from the one or more particular keywords in each document from the plurality of documents;
rank the plurality of documents based at least in part upon the determined frequency of occurrence of each keyword from the one or more particular keywords in each document from the plurality of documents, wherein a first document in which the determined frequency of occurrence of each keyword from the one or more particular keywords is higher than a frequency of occurrence of a counterpart keyword from the one or more particular keywords in other documents from the plurality of documents, is ranked hither than the other documents; and
determine that a second item in the search result is the first document, wherein the first document is added as the second item in the search result upon determining that the second item in the search result is the first document.

5. The system of claim 4, wherein the processor is further configured to determine that other items in the search result are a subset of documents from the plurality of documents in which the determined frequency of occurrence of each keyword from the one or more particular keywords is above a threshold frequency.

6. The system of claim 1, wherein the processor is further configured to:
in response to outputting the search result, receive feedback indicating whether the first text comprises the second response to the search string; and
in response to determining that the first text does not comprise the second response to the search string, adjust one or more weight values associated with the first set of features and the second set of features.

7. The system of claim 1, wherein the first intent tag comprises scheduling an appointment, editing an existing appointment, or viewing an existing appointment.

8. A method for determining search results for a search string based on detecting intent from the search string, comprising:
Receiving the search string;
accessing a training dataset comprising a first intent tag associated with at least a first text string among one or more text strings, wherein:
the first intent tag indicates a first intent of the first text string;
the first text string is associated with a first set of features representing the first intent of the first text string; and
the first intent tag is predetermined to be associated with a first text comprising a first response to the first text string;
determining an intent from the search string by extracting a second set of features from the search string, wherein:
the second set of features represents the intent of the search string; and
the intent is indicated by one or more particular keywords in the search string;
comparing the second set of features of the search string with the first set of features of the first text string to detect the intent from the search string;
determining whether the second set of features corresponds with the first set of features by determining a percentage of features of the second set of features that correspond to counterpart features of the first set of features;
in response to determining that the percentage of features of the second set of features that correspond to the counterpart features of the first set of features is more than a threshold percentage:
determining that the intent corresponds to the first intent tag;
producing a search result for the search string, wherein a first item in the search result is the first text associated with the first intent tag, and the first text comprises a second response to the search string; and
outputting the search result for the search string.

9. The method of claim 8, wherein:
the first set of features is represented by a first vector comprising a first set of numerical values,
the second set of features is represented by a second vector comprising a second set of numerical values,
determining whether the second set of features corresponds with the first set of features comprises:
comparing each numerical value of the first vector with a counterpart numerical value of the second vector;
determining whether each numerical value of the first vector corresponds to the counterpart numerical value of the second vector; and
in response to determining that more than the threshold percentage of the first set of numerical values correspond to counterpart numerical values of the second set of numerical values, determining that the second set of features corresponds with the first set of features.

10. The method of claim 8, further comprising:
accessing a second intent tag associated with at least a second text string among the one or more text strings from the training dataset, wherein the second text string is associated with a third set of features;
comparing the third set of features with the first set of features;
determining whether the third set of features corresponds with the first set of features by determining a second percentage of features of the third set of features that correspond to the counterpart features of the first set of features; and
in response to determining that the second percentage of features of the third set of features that correspond to the counterpart features of the first set of features is less than the threshold percentage, determining that the second intent tag does not correspond with the intent.

11. The method of claim 8, further comprising:
in response to determining that the percentage of features of the second set of features that correspond to the counterpart features of the first set of features is less than the threshold percentage:
determining a frequency of occurrence of each keyword from the one or more particular keywords in each document from a plurality of documents, wherein each document from the plurality of documents comprises a particular set of keywords indicating a particular concept associated with each document;
ranking the plurality of documents based at least in part upon the determined frequency of occurrence of each keyword from the one or more particular keywords in each document from the plurality of documents, wherein a first document in which the determined frequency of occurrence of each keyword from the one or more particular keywords is higher than a frequency of occurrence of a counterpart keyword from the one or more particular keywords in other documents from the plurality of documents, is ranked hither than the other documents; and
determining that a second item in the search result is the first document, wherein the first document is added as the second item in the search result upon determining that the second item in the search result is the first document.

12. The method of claim 11, further comprising determining that other items in the search result are a subset of documents from the plurality of documents in which the determined frequency of occurrence of each keyword from the one or more particular keywords is above a threshold frequency.

13. The method of claim 8, further comprising:
in response to outputting the search result, receiving feedback indicating whether the first text comprises the second response to the search string; and
in response to determining that the first text does not comprise the second response to the search string, adjusting one or more weight values associated with the first set of features and the second set of features.

14. The method of claim 8, wherein the first intent tag comprises scheduling an appointment, editing an existing appointment, or viewing an existing appointment.

15. A non-transitory computer-readable medium storing instructions that, when executed by a processor, causes the processor to:
receive a search string;
access a training dataset comprising a first intent tag associated with at least a first text string among one or more text strings, wherein:
the first intent tag indicates a first intent of the first text string;
the first text string is associated with a first set of features representing the first intent of the first text string; and
the first intent tag is predetermined to be associated with a first text comprising a first response to the first text string;
determine an intent from the search string by extracting a second set of features from the search string, wherein:
the second set of features represents the intent of the search string; and
the intent is indicated by one or more particular keywords in the search string;
compare the second set of features of the search string with the first set of features of the first text string to detect the intent from the search string;
determine whether the second set of features corresponds with the first set of features by determining a percentage of features of the second set of features that correspond to counterpart features of the first set of features;
in response to determining that the percentage of features of the second set of features that correspond to the counterpart features of the first set of features is more than a threshold percentage:
determine that the intent corresponds to the first intent tag;
produce a search result for the search string, wherein a first item in the search result is the first text associated with the first intent tag, and the first text comprises a second response to the search string; and
output the search result for the search string.

16. The computer-readable medium of claim 15, wherein:
the first set of features is represented by a first vector comprising a first set of numerical values,
the second set of features is represented by a second vector comprising a second set of numerical values, and
determining whether the second set of features corresponds with the first set of features comprises:
comparing each numerical value of the first vector with a counterpart numerical value of the second vector;
determining whether each numerical value of the first vector corresponds to the counterpart numerical value of the second vector; and
in response to determining that more than the threshold percentage of the first set of numerical values corresponds to counterpart numerical values of the second set of numerical values, determining that the second set of features corresponds with the first set of features.

17. The computer-readable medium of claim 15, wherein the instructions when executed by the processor, further cause the processor to:
access a second intent tag associated with at least a second text string among the one or more text strings from the training dataset, wherein the second text string is associated with a third set of features;
compare the third set of features with the first set of features;
determine whether the third set of features corresponds with the first set of features by determining a second percentage of features of the third set of features that correspond to the counterpart features of the first set of features; and
in response to determining that the second percentage of features of the third set of features that correspond to the counterpart features of the first set of features is less than the threshold percentage, determine that the second intent tag does not correspond with the intent.

18. The computer-readable medium of claim 15, wherein the instructions when executed by the processor, further cause the processor to:
in response to determining that the percentage of features of the second set of features that correspond to the counterpart features of the first set of features is less than the threshold percentage:
determine a frequency of occurrence of each keyword from the one or more particular keywords in each document from a plurality of documents, wherein each document from the plurality of documents comprises a particular set of keywords indicating a particular concept associated with each document;
rank the plurality of documents based at least in part upon the determined frequency of occurrence of each keyword from the one or more particular keywords in each document from the plurality of documents, wherein a first document in which the determined frequency of occurrence of each keyword from the one or more particular keywords is higher than a frequency of occurrence of a counterpart keyword from the one or more particular keywords in other documents from the plurality of documents, is ranked higher than the other documents; and
determine that a second item in the search result is the first document, wherein the first document is added as the second item in the search result upon determining that the second item in the search result is the first document.

19. The computer-readable medium of claim 18, wherein the instructions when executed by the processor, further cause the processor to determine that other items in the search result are a subset of documents from the plurality of documents in which the determined frequency of occurrence of each keyword from the one or more particular keywords is above a threshold frequency.

20. The computer-readable medium of claim 15, wherein the instructions when executed by the processor, further cause the processor to:
in response to outputting the search result, receive feedback indicating whether the first text comprises the second response to the search string; and
in response to determining that the first text does not comprise the second response to the search string, adjust one or more weight values associated with the first set of features and the second set of features.
